(19) United States
(12) Patent Application Publication
(10) Pub. No.: US 2020/0084416 A1
(43) Pub. Date: Mar. 12, 2020

(54) INFORMATION PROCESSING APPARATUS, CONTROL METHOD, AND PROGRAM

(71) Applicant: NEC CORPORATION, Tokyo (JP)

(72) Inventor: Tetsuo INOSHITA, Tokyo (JP)

(73) Assignee: NEC CORPORATION, Tokyo (JP)

(21) Appl. No.: 16/466,342

(22) PCT Filed: Dec. 5, 2016
(86) PCT No.: PCT/JP2016/086040

§ 371 Date: Jun. 4, 2019

(51) Int. Cl. H04N 7/18; G06K 9/00; G08B 13/196; G06T 7/20

(52) U.S. Cl. CPC H04N 7/181; G06K 9/00771; G06T 2207/30196; G06T 7/20; G06T 2207/30232; G08B 13/196

(57) ABSTRACT

A technology is provided which is capable of surveilling a dishonest action and which is easily introduced.

A first camera (10), a second camera (20), and a third camera (30) respectively generate a first captured image (11), a second captured image (21), and a third captured image (31). An exit (50) is imaged in the first captured image (11). An exhibition location (60) is imaged in the second captured image (21). A payment area (70) is imaged in the third captured image (31). An information processing apparatus (2000) detects a person from the first captured image (11), and determines whether or not the detected person is included in the second captured image (21). In a case where it is determined that the person who is detected from the first captured image (11) is included in the second captured image (21) and a degree of doubtfulness of the person is high, the information processing apparatus (2000) determines whether or not the person is included in the third captured image (31). In a case where the person is not detected from the third captured image (31), the information processing apparatus (2000) performs a warning process.

### TECHNICAL FIELD

The present invention relates to an information processing apparatus, a control method, and a program.

### BACKGROUND ART

There is a case where an exhibited product is thieved in a store. Here, in order to prevent the product from being thieved, a security guard is on guard while walking around in the store, or surveils a video of a surveillance camera.

However, a lot of labor is required to humanly perform surveillance. In addition, it is difficult to normally surveil all locations where products are exhibited humanly, and thus there is a possibility that leakage of surveillance occurs.

Here, a system is developed in order to prevent theft using an information processing technology. For example, Patent Document 1 discloses a system which images a face of a person who passes through a gate with a product, to which a tag is attached, using a camera provided in a vicinity of the gate, and searches the video of the surveillance camera for the imaged face.

Patent Document 2 discloses a system which determines whether or not a dishonest action is performed for a product which is an investigation target of the dishonest action such as shoplifting. Specifically, in cases where (1) a certain person stays above predetermined time in a store of a product of an investigation target, (2) the person does not return the product to a product shelf after picking the product up, and (3) the person comes out of the store, the system disclosed in Patent Document 2 searches for purchase history of the person. Furthermore, in a case where there is not the purchase history which indicates that the person purchases the product, the system disclosed in Patent Document 2 determines that the dishonest action is performed.

### RELATED DOCUMENT

### Patent Document

[Patent Document 1] Japanese Patent Application Publication No. 2011-233133

[Patent Document 2] Japanese Patent Application Publication No. 2009-284167

### SUMMARY OF THE INVENTION

### Technical Problem

The system disclosed in Patent Document 1 detects occurrence of theft by detecting a tag attached to a product. For this reason, in order to introduce the system, it is necessary to perform an operation of attaching the tag to each product, thereby requiring a lot of labor in order to introduce the system.

In order to introduce the system disclosed in Patent Document 2, it is necessary to introduce a purchase management system which is capable of recording “a customer and a product which is purchased by the customer” in addition to “the product which is purchased” as purchase history. Accordingly, in a store where the purchase management system is not introduced, replacement or the like of the purchase management system is necessary.

The present invention is made in view of the above-described problems. An object of the present invention is to provide a technology which is capable of surveilling a dishonest action and being easily introduced.

### Solution to Problem

An information processing apparatus according to the present invention comprising: (1) a detection unit that detects a person from a first captured image, the first captured image being generated by a first camera which is installed to be able to image an exit of a store; (2) a first determination unit that determines whether or not the person detected from the first captured image is included in a second captured image, the second captured image being generated by a second camera which is installed to be able to image an exhibition location of products of the store; (3) a second determination unit that determines whether or not the person who is included in the second captured image and whose degree of doubtfulness is high is included in a third captured image, the third captured image being generated by a third camera which is installed to be able to image a payment area of the store; and (4) a warning unit that performs a warning process in a case where it is determined that the person is not included in the third captured image by the second determination unit.

A control method according to the present invention is executed by a computer. The control method comprises: (1) a detection step of detecting a person from a first captured image, the first captured image being generated by a first camera which is installed to be able to image an exit of a store; (2) a first determination step of determining whether or not the person detected from the first captured image is included in a second captured image, the second captured image being generated by a second camera which is installed to be able to image an exhibition location of products of the store; (3) a second determination step of determining whether or not the person who is included in the second captured image and whose degree of doubtfulness is high is included in a third captured image, the third captured image being generated by a third camera which is installed to be able to image a payment area of the store; and (4) a warning step of performing a warning process in a case where it is determined that the person is not included in the third captured image in the second determination step.

A program according to the present invention causes a computer to execute each step included in the control method according to the present invention.

### Advantageous Effects of Invention

According to the present invention, there is provided a technology which is capable of surveilling a dishonest action and being easily introduced.

### BRIEF DESCRIPTION OF THE DRAWINGS

The above-described object, other objects, features, and advantages will be further clear through preferable embodiments which will be described below and accompanying drawing below.

FIG. 1 is a diagram illustrating installation locations of a plurality of types of cameras which are used by an information processing apparatus according to the first embodiment.

FIG. 2 is a diagram conceptually illustrating an operation of the information processing apparatus according to the first embodiment.

FIG. 3 is a diagram illustrating a configuration of the information processing apparatus according to the first embodiment.

FIG. 4 is a diagram illustrating a computer which is used to realize the information processing apparatus.

FIG. 5 is a flowchart illustrating a flow of a process executed by the information processing apparatus according to the first embodiment.

FIG. 6 is a diagram illustrating person information in a table form.

FIG. 7 is a diagram illustrating a method for computing the quantity of reduction in products.

FIG. 8 is a diagram illustrating scores assigned with respect to operations performed by a person in a table form.

FIG. 9 is a diagram illustrating scores assigned with respect to features of a movement path in the table form.

FIG. 10 is a diagram illustrating a warning message displayed on a display device.

FIG. 11 is a block diagram illustrating an information processing apparatus according to the second embodiment.

### DESCRIPTION OF EMBODIMENTS

Hereinafter, embodiments of the present invention will be described with reference to the accompanying drawings. Also, in all drawings, the same symbols are attached to the same components, and description is appropriately omitted. In addition, unless particular description is performed, each block in each block diagram represents a configuration in function units instead of a configuration in hardware units.

### First Embodiment

<Configuration of Information Processing Apparatus 2000>

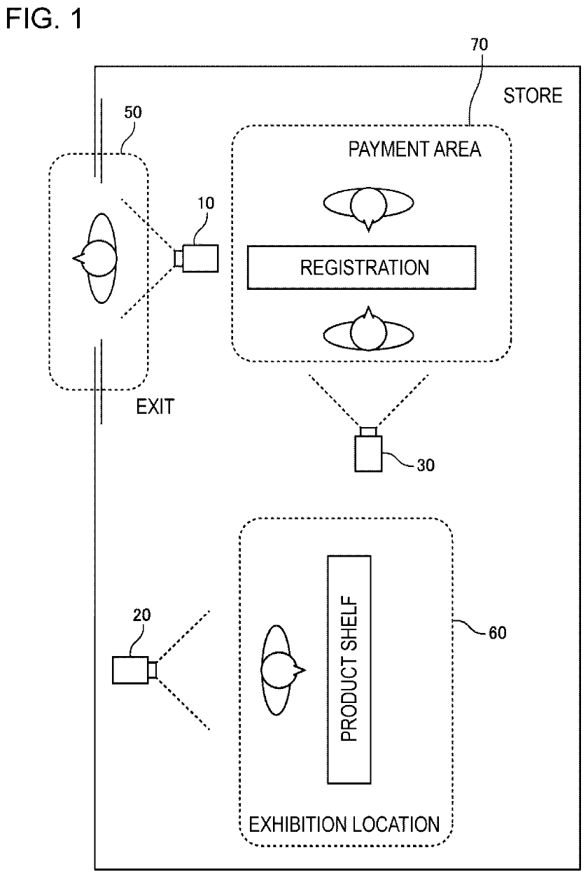

FIG. 1 is a diagram illustrating installation locations of a plurality of types of cameras which are used by an information processing apparatus 2000 according to the first embodiment. In a store where the information processing apparatus 2000 is used, the first camera 10, the second camera 20, and the third camera 30 are installed. The first camera 10 is installed to be able to image an exit (exit 50) of the store. The second camera 20 is installed to be able to image a product exhibition location (exhibition location 60) in the store. For example, products are exhibited on a product shelf installed in the exhibition location 60. The third camera 30 is installed to be able to image a location (payment area 70) where payment of a product is performed.

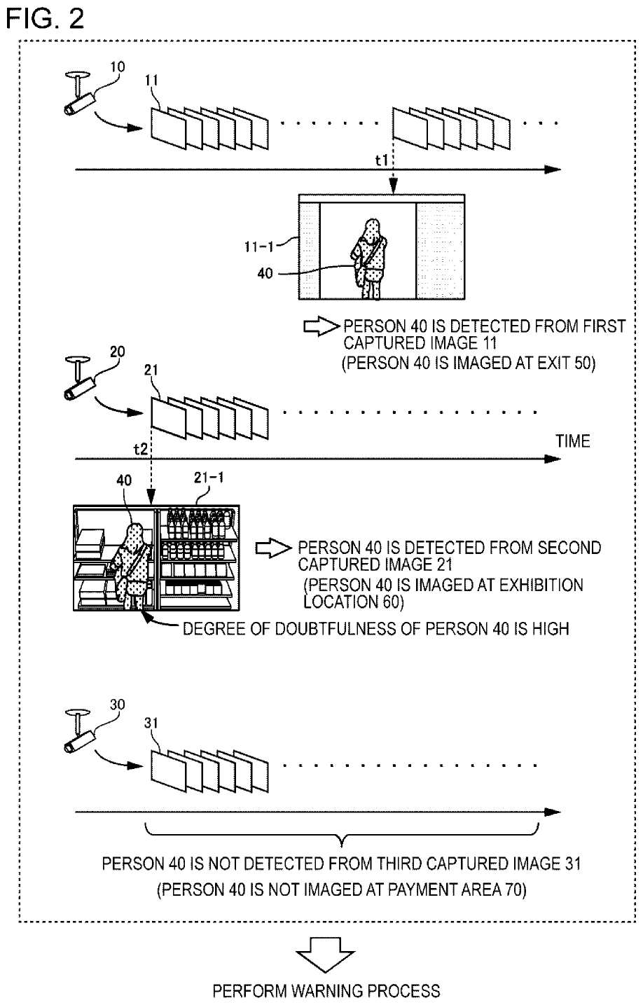

FIG. 2 is a diagram conceptually illustrating an operation of the information processing apparatus 2000 according to the first embodiment. Note that, FIG. 2 is a diagram used for illustration aiming at easy understand of the operation of the information processing apparatus 2000, and the operation of the information processing apparatus 2000 is not limited to FIG. 2.

The first camera 10, the second camera 20, and the third camera 30 respectively generate the first captured images 11, the second captured images 21, and the third captured images 31. The exit 50 is imaged in the first captured image 11. The exhibition location 60 is imaged in the second captured image 21. The payment area 70 is imaged in the third captured image 31.

The information processing apparatus 2000 detects a person from the first captured image 11. The person detected here may be a person imaged by the first camera 10 at the exit 50.

Subsequently, the information processing apparatus 2000 determines whether or not the person detected from the first captured image 11 is included in the second captured image 21. In other words, it is determined whether or not the person imaged at the exit 50 is also imaged at the exhibition location 60.

Furthermore, in a case where it is determined that the person detected from the first captured image 11 is included in the second captured image 21 and a degree of doubtfulness of the person is high, the information processing apparatus 2000 determines whether or not the person is also included in the third captured image 31. In other words, it is determined whether or not the person, who is imaged at both the exit 50 and the exhibition location 60 and whose degree of doubtfulness is high, is also imaged in the payment area 70.

Then, in a case where the person is not detected from the third captured image 31, the information processing apparatus 2000 performs a warning process. Accordingly, the warning process is performed in a case where the person, who is imaged at both the exit 50 and the exhibition location 60 and whose degree of doubtfulness is high, is not imaged in the payment area 70.

In FIG. 2, a person 40 is detected from the first captured image 11-1 which is imaged at time t1. Thus, the information processing apparatus 2000 tries to detect the person 40 from the second captured image 21. As a result, the person 40 is detected from the second captured image 21-1 at time t2. Furthermore, in an example of FIG. 2, the degree of doubtfulness of the person 40 is high. Here, the information processing apparatus 2000 also tries to detect the person 40 from the third captured image 31. As a result, the person 40 is not detected from the third captured image 31. Accordingly, the information processing apparatus 2000 performs the warning process.

Here, a level of the degree of doubtfulness of the person 40 may be computed using the second captured image 21, or may be computed using an image other than the second captured image 21. A method for computing the level of the degree of doubtfulness of the person 40 will be described in detail later.

### Advantageous Effects

In a case where the person who is imaged at the exit 50 is also imaged at the exhibition location 60, there is a possibility that the person comes out of the store after acquiring the product in the store. Furthermore, in a case where the degree of doubtfulness of the person is high, there is a possibility that the person acquires the product with a dishonest purpose such as theft. However, in a case where the person makes payment for the product in the payment area 70, it is considered that the person purchases the acquired product.

Here, the information processing apparatus 2000 according to the embodiment determines whether or not the person, who probably comes out of the store after acquiring the product (the person who is included in the first captured image 11 and the second captured image 21) and who has high possibility of performing a dishonest action (the person whose degree of doubtfulness is high), is imaged in the payment area 70. Furthermore, in a case where the person is not imaged in the payment area 70, the information processing apparatus 2000 performs the warning process. In this manner, the warning process is performed in a case where there is a high probability that theft or the like of the product is performed, and thus it is possible for a sales clerk or the like to recognize a situation such as a theft of the product in early stage and to perform a rapid action.

In addition, in a case where the information processing apparatus 2000 according to the embodiment is introduced, it is not necessary to attach a tag to a surveillance target product or to introduce a management system which records “a product which is purchased by a certain customer” as purchase history. Accordingly, it is possible to easily introduce the information processing apparatus 2000 according to the embodiment.

Hereinafter, the embodiment will be described in further detail.

<Example of Functional Configuration of Information Processing Apparatus 2000>

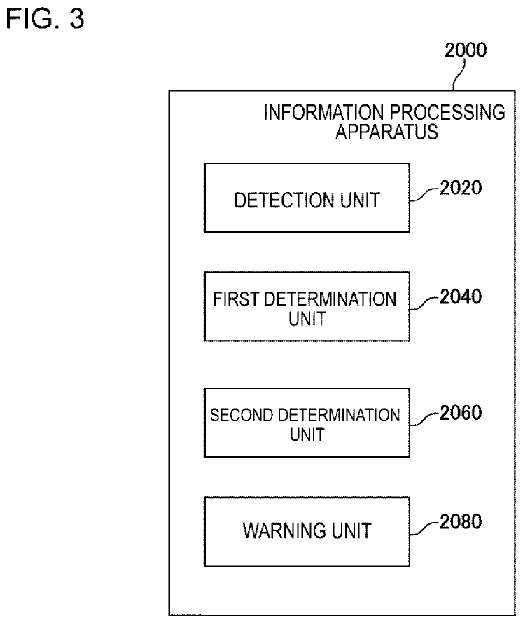

FIG. 3 is a diagram illustrating a configuration of the information processing apparatus 2000 according to the first embodiment. The information processing apparatus 2000 includes a detection unit 2020, a first determination unit 2040, a second determination unit 2060, and a warning unit 2080. The detection unit 2020 detects the person from the first captured image 11. The first determination unit 2040 determines whether or not the person detected from the first captured image 11 is included in the second captured image 21. In a case where the person detected from the first captured image 11 is included in the second captured image 21 and the degree of doubtfulness of the person is high, the second determination unit 2060 determines whether or not the person is included in the third captured image 31. In a case where the person is not included in the third captured image 31, the warning unit 2080 performs the warning process.

<Hardware Configuration of Information Processing Apparatus 2000>

Respective functional configuration units of the information processing apparatus 2000 may be realized by hardware (for example, a hard-wired electronic circuit or the like) which realizes the respective functional configuration units, or may be realized through a combination (for example, a combination of an electronic circuit and a program, which controls the electronic circuit, or the like) of hardware and software. Hereinafter, a case where the respective functional configuration units of the information processing apparatus 2000 are realized through the combination of the hardware and the software will be further described.

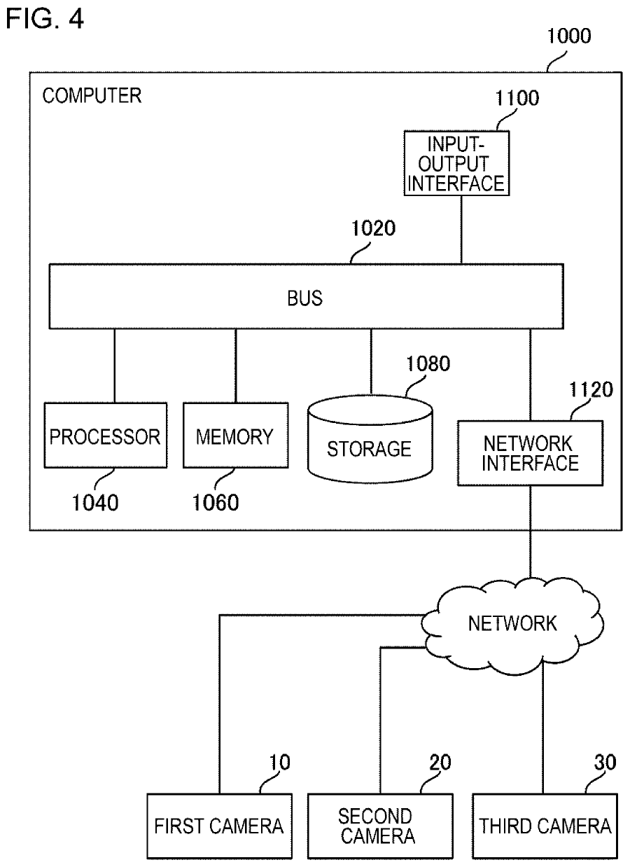

FIG. 4 is a diagram illustrating a computer 1000 which is used to realize the information processing apparatus 2000. The computer 1000 is an arbitrary computer. For example, the computer 1000 is a Personal Computer (PC), a server machine, a tablet terminal, a smartphone, or the like. The computer 1000 may be a dedicated computer which is designed to realize the information processing apparatus 2000, or a general-purpose computer.

The computer 1000 includes a bus 1020, a processor 1040, a memory 1060, a storage device 1080, an input-output interface 1100, and a network interface 1120. The bus 1020 is a data transmission line which is used for the processor 1040, the memory 1060, the storage device 1080, the input-output interface 1100, and the network interface 1120 to transmit and receive data to and from each other. However, a method for connecting the processor 1040 and the like to each other is not limited to bus connection. The processor 1040 is a processor such as a Central Processing Unit (CPU) or a Graphics Processing Unit (GPU). The memory 1060 is a main memory unit which is realized using a Random Access Memory (RAM) or the like. The storage device 1080 is a secondary storage unit which is realized using a hard disk, a Solid State Drive (SSD), a memory card, a Read Only Memory (ROM), or the like. However, the storage device 1080 may include hardware which is the same as hardware, such as the RAM, included in the main memory unit.

The input-output interface 1100 is an interface which is used to connect the computer 1000 to an input-output device. The network interface 1120 is an interface which is used to connect the computer 1000 to a communication network. The communication network is, for example, a Local Area Network (LAN) or a Wide Area Network (WAN). A method for connecting to the communication network by the network interface 1120 may be wireless connection or wired connection.

For example, the computer 1000 is communicably connected to the first camera 10, the second camera 20, and the third camera 30 through the network. However, a method for communicably connecting the computer 1000 to the respective cameras is not limited to connection through the network. In addition, the computer 1000 may not be communicably connected to the respective cameras.

The storage device 1080 stores program modules which realize the respective functional configuration units (the detection unit 2020, the first determination unit 2040, the second determination unit 2060, and the warning unit 2080) of the information processing apparatus 2000. The processor 1040 realizes functions corresponding to the respective program modules by reading and executing the respective program modules in the memory 1060.

Note that, the computer 1000 may be realized using a plurality of computers. For example, it is possible to realize the detection unit 2020, the first determination unit 2040, the second determination unit 2060, and the warning unit 2080 using different computers, respectively. In this case, the respective program modules which are stored in storage devices of the computers may be only program modules corresponding to the functional configuration units which are realized by the relevant computers.

<As to Camera>

Each of the first camera 10, the second camera 20, and the third camera 30 is an arbitrary camera which is capable of generating a plurality of captured images through repeated imaging. Each of the cameras may be a video camera which generates video data or may be a still camera which generates still image data. In a former case, the first captured image 11, the second captured image 21, and the third captured image 31 are image frames included in the video data.

The respective cameras are, for example, surveillance cameras. In a case where the computer 1000 is realized using the plurality of computers as described above, the respective cameras may be used to realize the computer 1000. For example, it is possible to realize the detection unit 2020 using the first camera 10. In this case, the first camera 10 detects the person from the first captured image 11 which is generated by the first camera 10.

In another example, it is possible to realize the first determination unit 2040 using the second camera 20. In this case, the second camera 20 determines whether or not the person detected from the first captured image 11 is included in the second captured image 21 which is generated by the second camera 20.

In another example, it is possible to realize the second determination unit 2060 using the third camera 30. The third camera 30 determines whether or not the person, who is included in both the first captured image 11 and the second captured image 21 and whose degree of doubtfulness is high, is included in the third captured image 31 which is generated by the third camera 30. In addition, furthermore, the warning unit 2080 may be realized using the third camera 30. In this case, the third camera 30 performs the warning process in a case where the person is not included in the third captured image 31.

It is possible to use a camera, which is called, for example, an intelligent camera, a network camera, or an Internet Protocol (IP) camera, as each of the cameras which are used to realize the computer 1000.

<Flow of Process>

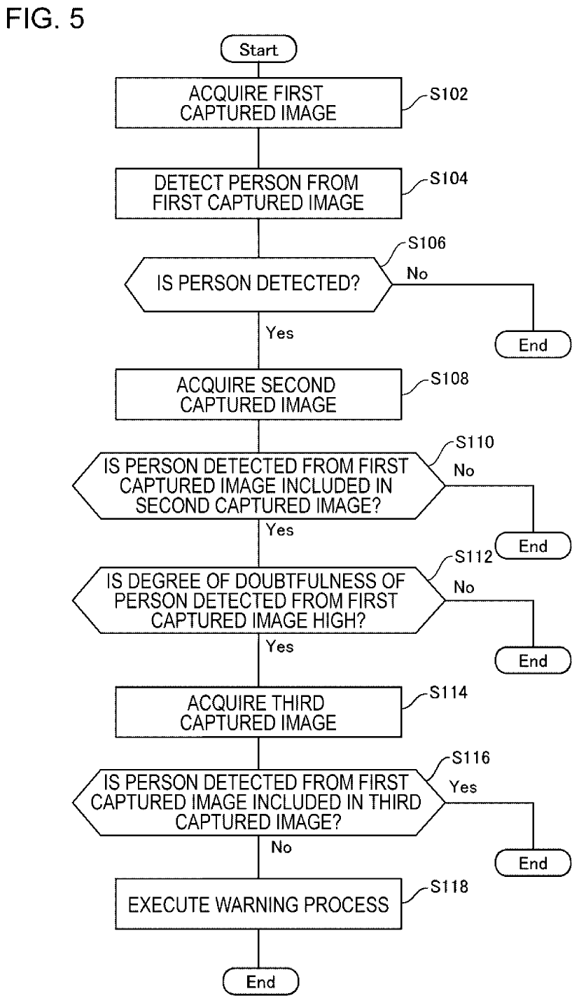

FIG. 5 is a flowchart illustrating a flow of a process executed by the information processing apparatus 2000 according to the first embodiment. The detection unit 2020 acquires the first captured image 11 (S102). The detection unit 2020 detects the person from the first captured image 11 (S104). In a case where the person is not detected from the first captured image 11 (S106: NO), the process of FIG. 5 ends.

In a case where the person is detected from the first captured image 11 (S106: YES), the first determination unit 2040 acquires the second captured image 21 (S108). The first determination unit 2040 determines whether or not the person detected from the first captured image 11 is included in the second captured image 21 (S110). In a case where the person detected from the first captured image 11 is not included in the second captured image 21 (S110: NO), the process of FIG. 5 ends.

In a case where the person detected from the first captured image 11 is included in the second captured image 21 (S110: YES), the second determination unit 2060 determines whether or not the degree of doubtfulness of the person is high (S112). In a case where the degree of doubtfulness of the person is not high (S112: NO), the process of FIG. 5 ends.

In a case where the degree of doubtfulness of the person is high (S112: YES), the second determination unit 2060 acquires the third captured image 31 (S114). The second determination unit 2060 determines whether or not the person is included in the third captured image 31 (S116). In a case where the person is included in the third captured image 31 (S116: YES), the process of FIG. 5 ends.

In a case where the person is not included in the third captured image 31 (S116: NO), the warning unit 2080 executes the warning process (S118).

Note that, the flow of the process illustrated in FIG. 5 is merely an example, and the flow of the process executed by the information processing apparatus 2000 is not limited to the flow illustrated in FIG. 5. For example, it is possible to set a timing, in which each captured image is acquired, to an optional timing before the captured image is used. For example, the first determination unit 2040 may acquire the second captured image 21 before it is determined whether or not the person is detected from the first captured image 11 (S106). In the same manner, the second determination unit 2060 may acquire the third captured image 31 before it is determined whether or not the person detected from the first captured image 11 is included in the second captured image 21 (S110) or it is determined whether or not the degree of doubtfulness of the person is high (S112).

<Method for Acquiring First Video 12: S102>

The detection unit 2020 acquires the first captured image 11 (S102). Here, a method for acquiring the first captured image 11 by the detection unit 2020 is optional. For example, the detection unit 2020 receives the first captured image 11 which is transmitted from the first camera 10. In another example, the detection unit 2020 accesses the first camera 10, and acquires the first captured image 11 which is stored in the first camera 10.

Note that, the first camera 10 may store the first captured image 11 in a storage unit which is provided on the outside of the first camera 10. In this case, the detection unit 2020 accesses the storage unit and acquires the first captured image 11.

In a case where the detection unit 2020 is realized using the first camera 10, the detection unit 2020 acquires the first captured image 11 generated by the first camera 10 which realizes the detection unit 2020. In this case, the first captured image 11 is stored in, for example, a storage unit which exists inside the first camera 10. Here, the detection unit 2020 acquires the first captured image 11 from the storage unit.

There are various timings in which the detection unit 2020 acquires the first captured image 11. For example, the detection unit 2020 acquires the first captured image 11 every time when a new first captured image 11 is generated by the first camera 10. In another example, the detection unit 2020 may periodically acquire the first captured image 11 which is not acquired. For example, in a case where the detection unit 2020 acquires the first captured image 11 once per second, the detection unit 2020 collectively acquires a plurality of first captured images 11 which are generated for one second (for example, 30 first captured images 11 in a case of a 30 fps (frames/second) camera.)

<Detection of Person from First Captured Image 11: S104>

The detection unit 2020 detects the person from the first captured image 11 (S104).

Specifically, the detection unit 2020 detects the person from the first captured image 11 by detecting an area representing the person from the first captured image 11. Hereinafter, the area representing the person is called a person area.

There are various methods for detecting the person area from the first captured image 11. For example, the detection unit 2020 detects the person area through feature matching or template matching. In a former case, the detection unit 2020 detects an area that includes a feature-value (hereinafter, a person feature-value) representing a feature of a physical appearance of the person among areas included in the first captured image 11. In a latter case, the detection unit 2020 detects, as the person area, an area whose degree of similarity with a template image representing the person is high among the areas included in the first captured image 11. Note that, the person feature-value and the template image are defined in advance.

Note that, there is a case where it is not preferable to image a front surface of a face of the person using the camera from a point of view of privacy protection or the like. Thus, it is preferable to install each camera (the first camera 10, the second camera 20, and the third camera 30) so as to image the person from a direction in which there is a low probability that the front surface of the face of the person is imaged. For example, each of the cameras are installed to face a direction which is the same as a direction of a movement path of the person in the store.

In a case where the first camera 10 is installed such that there is a low probability that the front surface of the face of the person is imaged as described above, there is a high probability that features (eyes, nose, mouth, and the like) of the front surface of the face of the person are not included in the first captured image 11. Here, in this case, the detection unit 2020 is configured to be able to detect the person from the first captured image 11 in which a back view of the person is imaged. For example, in a case where feature matching is used, at least a feature of the physical appearance of the back view of the person is defined as the person feature-value. In addition, in a case where template matching is used, at least a template image which represents the back view of the person is defined.

<Information Related to Detected Person>

The first determination unit 2040 determines whether or not the person detected from the first captured image 11 is included in the second captured image 21. In order to perform the determination, information specifying the person detected from the first captured image 11 is necessary.

Here, the detection unit 2020 generates the information specifying the person detected from the first captured image 11. Hereinafter, this information is called person information. For example, the detection unit 2020 stores the person information in the storage unit which can be accessed from the first determination unit 2040. In another example, the detection unit 2020 may output the person information to the first determination unit 2040.

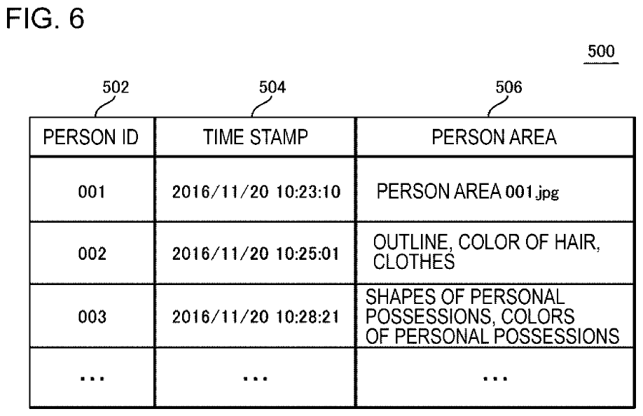

FIG. 6 is a diagram illustrating the person information in the table form. A table of FIG. 6 is referred to as person information table 500. The person information table 500 includes a person ID 502, a time stamp 504, and a person area 506. The person ID 502 is an identifier which is assigned to the person detected from the first captured image 11 by the detection unit 2020. The time stamp 504 represents a time when the first captured image 11 from which the person is detected is generated. The person area 506 is information used to determine the person area which is detected from the first video 12. Note that, a method for assigning the identifier with respect to the person detected from the first captured image 11 is optional.

The person area 506 may indicate the detected person area itself (a set of values of respective pixels included in the person area) or may indicate a feature of the detected person. The feature of the extracted person indicates, for example, a body shape (outline or the like) of the person. In another example, the feature of the extracted person indicates clothes, a color of hair, a color of skin, and the like of the person. In another example, the feature of the extracted person indicates shapes, colors, or the like of personal possessions.

<Acquisition of Second Captured Image 21: S108>

The first determination unit 2040 acquires the second captured image 21 (S108). As a method for acquiring the second captured image 21 by the first determination unit 2040, it is possible to use the same method for acquiring the first captured image 11 by the detection unit 2020.

There are various timings in which the first determination unit 2040 acquires the second captured image 21. For example, the first determination unit 2040 acquires the second captured image 21 at the same timing as the timing at which the detection unit 2020 acquires the first captured image 11. In another example, the first determination unit 2040 may acquire the second captured image 21 according to the fact that the person is detected from the first captured image 11 by the detection unit 2020. In this case, for example, the first determination unit 2040 acquires the second captured image 21 at a timing in which the above-described person information generated by the detection unit 2020 is acquired.

Note that, the first determination unit 2040 may acquire all or a part of the second captured image 21 generated by the second camera 20. Here, the person included in the first captured image 11 is imaged at the exit 50, and the person included in the second captured image 21 is imaged at the exhibition location 60. For this reason, in a case where the same person is included in the first captured image 11 and the second captured image 21, the time when the second captured image 21 is generated may be before the time when the first captured image 11 is generated. Here, in a case where only a part of the second captured image 21 generated by the second camera 20 is acquired, for example, the first determination unit 2040 acquires only the second captured image 21 which is generated before the time when the first captured image 11 from which the person is detected is generated (time stamp indicated by the acquired person information). In this manner, it is possible to reduce processing loads of the information processing apparatus necessary to acquire the second captured image 21, utilization of the bandwidth of the network used to acquire the second captured image 21, and the like.

<Detection of Person from Second Captured Image 21: S110>

The first determination unit 2040 determines whether or not the person detected from the first captured image 11 is included in the second captured image 21 (S110). As described above, the person detected from the first captured image 11 is specified using the person information generated by the detection unit 2020. Here, the first determination unit 2040 performs the determination using the person information generated by the detection unit 2020.

The second captured image 21 to be used for the determination is the second captured image 21 generated at a time before the time when the first captured image 11 from which a target person is detected is generated.

There are various concrete methods for performing the determination by the first determination unit 2040. Hereinafter, some methods will be illustrated.

### First Example of Determination Method

The first determination unit 2040 attempts to detect the person specified by the person information for each second captured image 21. Furthermore, in a case where the person is detected from any of the second captured image 21, the first determination unit 2040 determines that the person detected from the first captured image 11 is included in the second captured image 21 (S110: YES). On the other hand, in a case where the person is not detected from any of the second captured image 21, the first determination unit 2040 determines that the person detected from the first captured image 11 is not included in the second captured image 21 (S110: NO).

For example, it is assumed that the person information represents the person area extracted from the first captured image 11. In this case, the first determination unit 2040 detects the person specified by the person information by detecting an area whose degree of similarity with the person area is high from the second captured image 21.

In another example, it is assumed that the person information represents the feature of the person extracted from the first captured image 11. In this case, the first determination unit 2040 detects the person specified by the person information by detecting a person who has a feature indicated by the person information from the second captured image 21.

### Second Example of Determination Method

The first determination unit 2040 also detects the person from the second captured image 21 using the same method as the method for detecting the person from the first captured image 11 by the detection unit 2020. Furthermore, the first determination unit 2040 determines whether or not the persons detected from the second captured image 21 include the same person as that detected from the first captured image 11.

For example, the first determination unit 2040 detects persons from one or more acquired second captured images 21, and generates pieces of person information for each person detected. Furthermore, the first determination unit 2040 matches the person information generated by the detection unit 2020 with the person information generated by the first determination unit 2040.

In a case where there is person information that specifies the same person as the person determined by the person information generated by the detection unit 2020 in the person information generated by the first determination unit 2040, the first determination unit 2040 determines that the person detected by the first captured image 11 is included in the second captured image 21 (S110: YES). On the other hand, in a case where there is no person information that specifies the same person as the person determined by the person information generated by the detection unit 2020 in the person information generated by the first determination unit 2040, the first determination unit 2040 determines that the person detected by the detection unit 2020 is not included in the second captured image 21 (S110: NO).

<Acquisition of Third Captured Image 31: S114>

The second determination unit 2060 acquires the third captured image 31 (S114). A method for acquiring the third captured image 31 by the second determination unit 2060 is the same as the method for acquiring the first captured image 11 by the detection unit 2020.

There are various timings that the second determination unit 2060 acquires the third captured image 31. For example, the second determination unit 2060 acquires the third captured image 31 at the same timing as the timing at which the detection unit 2020 acquires the first captured image 11. In another example, the second determination unit 2060 may acquire the third captured image 31 according to the facts that it is determined that the person detected from the first captured image 11 is included in the second captured image 21 (S110: YES) and it is determined that the degree of doubtfulness of the person is high (S112: YES) (See FIG. 5).

Note that, the second determination unit 2060 may acquire all or a part of the third captured image 31 generated by the third camera 30. In a latter case, for example, the second determination unit 2060 acquires only the third captured image 31 which is generated during a period between the time when the second captured image 21 including the person to be determined whether or not to be included in the third captured image 31 is generated, and the time when the first captured image 11 including the person is generated. This is because a certain person may be imaged at the payment area 70 (imaging range of the third camera 30) between the time when the person is imaged at the exhibition location 60 (the time when the product is acquired from the exhibition location 60) and the time when the person is imaged at the exit 50 (the time when the person attempts to come out of the exit 50). In a case where only a part of the third captured image 31 is acquired, it is possible to reduce processing loads of the information processing apparatus 2000 necessary to acquire the third captured image 31, the utilization of the network bandwidth used to acquire the third captured image 31, and the like.

<Determination by Second Determination Unit 2060: S116>

The second determination unit 2060 determines whether or not a person who satisfies two conditions is included in the third captured image (S116), the two conditions being (1) being included in both the first captured image 11 and the second captured image 21, and (2) having high level of degree of doubtfulness. The person who is included in both the first captured image 11 and the second captured image 21 is the person who is detected from the detection unit 2020 and the person who is determined to be included in the second captured image 21 by the first determination unit 2040.

The second determination unit 2060 determines whether or not the degree of doubtfulness is high for the person who is detected from the detection unit 2020 and is determined to be included in the second captured image 21 by the first determination unit 2040 (S112). The determination method will be described in detail later.

In a case where it is determined that the degree of doubtfulness is high (S112: YES), the second determination unit 2060 determines whether or not the person is included in the third captured image 31 (S116). On the other hand, in a case where it is determined that the degree of doubtfulness is not high (S112: NO), the second determination unit 2060 may not determine whether or not the person is included in the third captured image 31.

The third captured image 31 to be used for the determination is that generated at or before the time when the first captured image 11 from which the target person is detected is generated, and is that generated after the time when the second captured image 21 from which the target person is detected is generated.

Note that, a method for determining whether or not the person is included in the third captured image 31 is the same as the method for determining whether or not the person detected by the detection unit 2020 is included in the second captured image 21 (for example, the first method and the second method which are described above). The person information to be used for the determination may be acquired from the first determination unit 2040 or may be acquired from the storage unit which can be accessed by the second determination unit 2060. In a latter case, the first determination unit 2040 writes the person information of the person who is determined to be included in the second captured image 21 into the storage unit which can be accessed by the second determination unit 2060.

<Determination of Height of Degree of Doubtfulness: S112>

As described above, the second determination unit 2060 determines whether or not the degree of doubtfulness is high for the person who is detected from the detection unit 2020 and is determined to be included in the second captured image 21 by the first determination unit 2040 (S112). For example, the second determination unit 2060 computes the degree of doubtfulness of the person as a numerical value. Furthermore, in a case where the computed degree of doubtfulness is equal to or larger than a predetermined value, the second determination unit 2060 determines that the degree of doubtfulness of the person is high. The predetermined value may be set in the second determination unit 2060 in advance or may be stored in the storage unit which can be accessed from the second determination unit 2060.

Hereinafter, a method for computing the degree of doubtfulness of the person will be described.

### First Example of Computation Method

For example, the second determination unit 2060 computes the quantity of reduction in products between before and after a period during which the target person (the person detected from the first captured image 11) is included in the second captured image 21, as the degree of doubtfulness of the person. That is, the more the number of products reduces between before and after the person appears in front of the exhibition location 60, the higher the degree of doubtfulness of the person is.

For example, the second determination unit 2060 computes a difference between the quantity of products included in the second captured image 21 generated before the target person is included in the imaging range of the second camera 20 and the quantity of products included in the second captured image 21 generated after the person is not included in the imaging range of the second camera 20, and handles the computed difference as the degree of doubtfulness of the person. It is possible to use a well-known technique as a technique to compute the difference of the amount of objects included in two images.

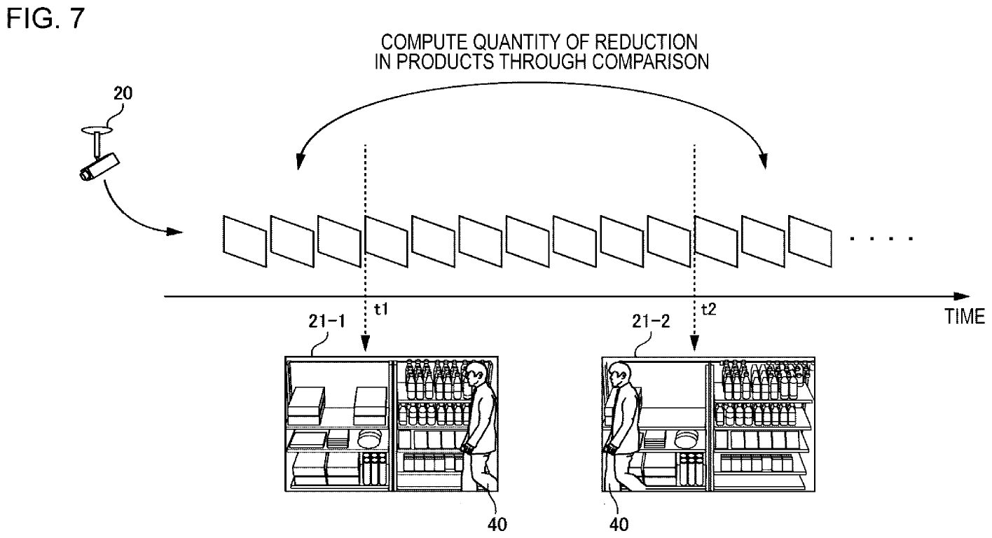

FIG. 7 is a diagram illustrating a method for computing the quantity of reduction in products. The target person is included in respective second captured images 21 between a second captured image 21-1 generated at the time t1 and a second captured image 21-2 generated at the time t2. Here, the second determination unit 2060 computes the quantity of reduction in products by comparing the second captured image 21 generated before the time t1 (for example, the second captured image 21 which is generated immediately before the second captured image 21-1) with the second captured image 21 generated after the time t2 (for example, the second captured image 21 which is generated immediately after the second captured image 21-2).

### Second Example of Computation Method

For example, the second determination unit 2060 computes staying time of the target person in the exhibition location 60 as the degree of doubtfulness of the person. In this case, the longer the staying time of the person in the exhibition location 60 is, the higher the degree of doubtfulness of the person is.

It is possible to compute the staying time of the target person in the exhibition location 60 using, for example, the second captured image 21. Specifically, in order to compute staying time of a certain person in the exhibition location 60, the second determination unit 2060 determines the second captured image 21 in which the person is included, among the second captured images 21 generated by the second camera 20 which images the exhibition location 60. Furthermore, the second determination unit 2060 computes, among the determined second captured images 21, a difference between the time when the second captured image 21 having the latest time of generation is generated and the time when the second captured image 21 having the earliest time of generation is generated, and handles the computed value as the staying time of the person in the exhibition location 60. For example, in FIG. 7, the staying time of the target person stays is t2−t1.

### Third Example of Computation Method

For example, the second determination unit 2060 computes the degree of doubtfulness of the person based on an action performed by the target person in the exhibition location 60.

Specifically, scores representing the degrees of doubtfulness of the actions are defined in advance, with respect to various doubtable actions which may be performed by the person. Furthermore, the second determination unit 2060 sums up the scores corresponding to the respective actions performed by the certain person, and handles the computed total value as the degree of doubtfulness of the person.

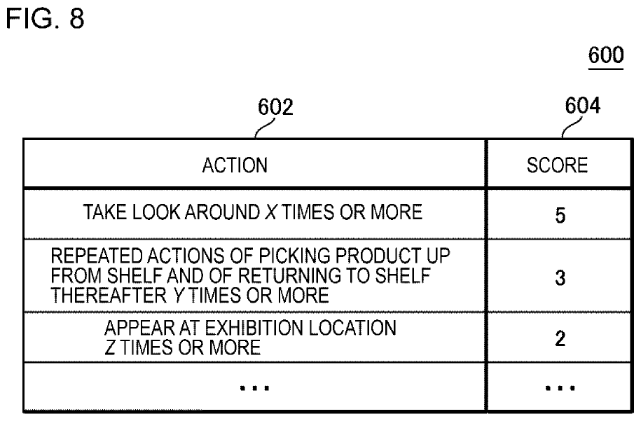

FIG. 8 is a diagram illustrating the scores assigned with respect to the actions of the person in the table form. A table of FIG. 8 is called action score table 600. An action 602 indicates content of the action. A score 604 indicates a score of the action indicated by the action 602.

It is possible to determine each action performed by the person in the exhibition location 60 by performing image analysis on the second captured image 21 generated by the second camera 20 which images the exhibition location 60. It is possible to use a well-known technique as a technique to determine the action performed by the person through the image analysis.

### Fourth Example of Computation Method

For example, the second determination unit 2060 computes the degree of doubtfulness of the person based on a path of movement (trajectory) of the target person in the store. Specifically, scores representing the degrees of doubtfulness of features are defined in advance with respect to various features of the trajectory. Furthermore, the second determination unit 2060 sums up the scores corresponding to the respective features of the trajectory of the certain person in the store, and handles the computed total value as the degree of doubtfulness of the person.

There are various features of the trajectory considered to be doubtful. For example, the features of the trajectory considered to be doubtful includes (1) passing through the same exhibition location 60 a lot of time (equal to or larger than a predetermined number of times), (2) staying in the vicinity of the same exhibition location for long time (equal to or longer than predetermined time), (3) passing through a specified area a lot of times (equal to or larger than a predetermined number of times), (4) a low degree of coincidence with the trajectory assumed in advance, and the like. The specified area is a location which is considered that the theft or the like of the product easily occurs. The location which is considered that the theft or the like of the product easily occurs includes, for example, a blind spot of the surveillance camera. In the blind spot of the surveillance camera, an action such as “putting an unpaid product in a bag” may be easily performed, and therefore the theft or the like of the product may easily occur. Note that, the pieces of information described above such as the predetermined number of times, the predetermined time, the specified area, and the trajectory assumed in advance may be set in the second determination unit 2060 in advance or may be stored in the storage unit which can be accessed from the second determination unit 2060.

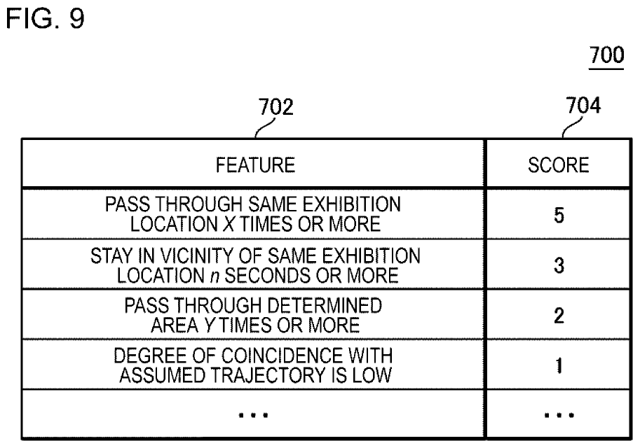

FIG. 9 is a diagram illustrating scores assigned with respect to the features of the trajectory in the table form. The table of FIG. 9 is referred to as trajectory score table 700. The feature 702 indicates the feature of the trajectory. The score 704 indicates the score of the feature of the trajectory indicated in the feature 702.

It is possible to use a well-known technique as a technique to recognize the trajectory of the person in the store. For example, it is possible to recognize the trajectory of the person by analyzing the captured images which are generated by the cameras installed in various locations of the store, and tracking the location of the person.

<Execution of Warning Process: S118>

In a case where the person who satisfies conditions (1) and (2) does not included in any of the third captured image 31 (S116: NO), the warning unit 2080 executes the warning process (S118). Here, it is possible to use various warning processes which are performed by the warning unit 2080. For example, the warning unit 2080 outputs a warning message from an output device which is connected to the information processing apparatus 2000. The output device includes, for example, a display device, a speaker, and the like.

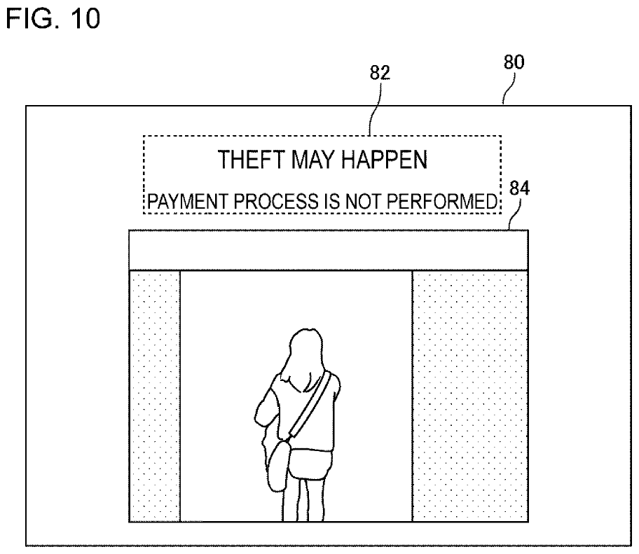

FIG. 10 is a diagram illustrating a warning message displayed on the display device. A warning screen 80 includes a warning message 82 and a captured image 84. The warning message 82 is a message which represents that there is a possibility of the theft. The captured image 84 is the first captured image 11 in which the person who is determined to be not included in the third captured image 31 by the second determination unit 2060 is detected (the person who has a possibility of performing the dishonest action such as the theft).

In a case where the warning screen 80 is viewed, it is possible for the sales clerk, an observer, or the like to easily recognize a fact that there is a possibility that the dishonest action like theft occurred and information of the person (physical appearance or the like) who performs the dishonest action.

The warning message may be output to a non-portable output device which is installed in a security guard room or at a registration terminal, or may be output to a portable medium such as a mobile terminal. For example, the mobile terminal is a mobile terminal possessed by the sales clerk or the security guard of the store. The mobile terminal having acquired the warning message output from the warning unit 2080 outputs the warning message from the display device or the speaker of the mobile terminal. For example, the same warning screen as in FIG. 10 is output to the display device of the mobile terminal.

In another example, the warning unit 2080 may execute the warning process for causing the gate (automatic door or the like) at the exit 50 of the store to become unable to be passed through. For example, the warning unit 2080 closes the gate and locks the closed gate. In this manner, the person who is determined to be not included in the third captured image 31 by the second determination unit 2060 (person who has a possibility of performing the dishonest action such as the theft) becomes unable to leave from the store.

Note that, in a case where the warning process for causing the gate to become unable to be passed through is used, it is preferable that the third camera 30 is installed to image a person who faces the gate of the exit 50 instead of the person who passes through the gate of the exit 50. In this manner, it is possible to cause the gate of the exit 50 more certainly to become unable to be passed through before the person comes out of the store.

### Second Embodiment

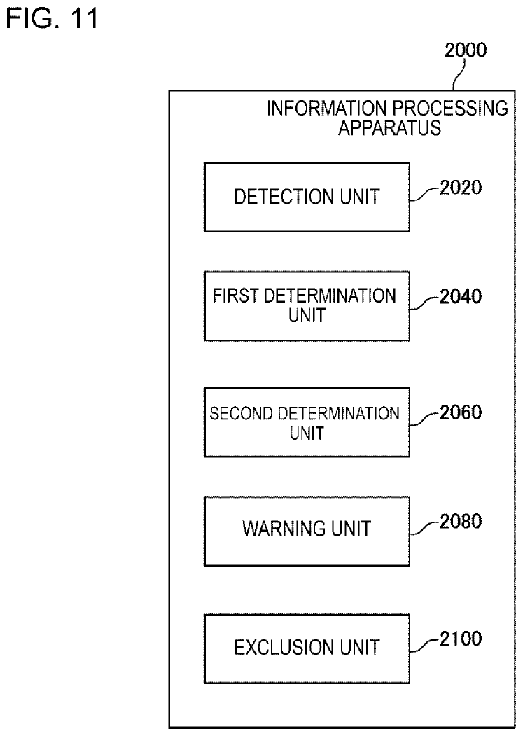

FIG. 11 is a block diagram illustrating an information processing apparatus 2000 according to a second embodiment. Other than matters described below, the information processing apparatus 2000 according to the second embodiment include the same functions as the information processing apparatus 2000 according to the first embodiment.

As illustrated in FIG. 5 according to the first embodiment, in a case where the person is detected from the detection unit 2020 (S106: YES), it is determined whether or not to execute the warning process regarding the person (S108 to S116), and the warning process is executed (S118). Since the person who is detected from the detection unit 2020 comes out of the store from the exit 50, it may become unnecessary to process the captured image which includes only the person after a series of processes related to the person are completed.

Here, the information processing apparatus 2000 according to the second embodiment includes an exclusion unit 2100. After the series of processes related to the person detected from the first captured image 11 are completed, the exclusion unit 2100 excludes the first captured image 11, the second captured image 21, and the third captured image 31 which include only the person, from the target of the process by the information processing apparatus 2000. “After the series of processes related to the person detected from the first captured image 11 are completed” indicates (1) after it is determined that the person is not included in the second captured image 21 by the first determination unit 2040 (S110: NO), (2) after it is determined that the degree of doubtfulness of the person is not high by the second determination unit 2060 (S112: NO), or (3) after it is determined whether or not the person is included in the third captured image 31 by the second determination unit 2060 (S116).

In a case where the captured images on which the process by the information processing apparatus 2000 is completed are excluded from the target of the process of the information processing apparatus 2000 as described above, it is possible to reduce process loads of the information processing apparatus 2000.

Here, there are various methods for excluding each captured image from the target of the process of the information processing apparatus 2000. For example, the exclusion unit 2100 removes, from the storage unit, each captured image which is excluded from the target of the process. In another example, a flag which represents whether or not being included in the target of the process of the information processing apparatus 2000 is provided in metadata of the captured image, and the flag may be used. An initial value of the flag is set to “being included in the target of the process of the information processing apparatus 2000.” Furthermore, the exclusion unit 2100 excludes the captured image from the target of the process of the information processing apparatus 2000 by changing the value of the flag of the captured image to “being not included in the target of the process of the information processing apparatus 2000.” In this case, the detection unit 2020, the first determination unit 2040, and the second determination unit 2060 according to the second embodiment perform each process using only the captured image whose value of the flag is “being included in the target of the process of the information processing apparatus 2000”, as the target.

### Example of Hardware Configuration

A hardware configuration of a computer which realizes the information processing apparatus 2000 according to the second embodiment is represented with reference to, for example, FIG. 4 as the same as in the first embodiment. However, program modules, which realize functions of the information processing apparatus 2000 according to the embodiment, are further stored in the storage device 1080 of the computer 1000 which realizes the information processing apparatus 2000 according to the embodiment.

Hereinabove, although the embodiments of the present invention are described with reference to the accompanying drawings, the embodiments are examples of the present invention, and it is possible to use a combination of the above-described respective embodiments or various configurations other than the embodiments.

Although a part or whole of the embodiments is described as supplements below, the present invention is not limited thereto.

1. An information processing apparatus comprising:

a detection unit that detects a person from a first captured image, the first captured image being generated by a first camera which is installed to be able to image an exit of a store;

a first determination unit that determines whether or not the person detected from the first captured image is included in a second captured image, the second captured image being generated by a second camera which is installed to be able to image an exhibition location of products of the store;

a second determination unit that determines whether or not the person who is included in the second captured image and whose degree of doubtfulness is high is included in a third captured image, the third captured image being generated by a third camera which is installed to be able to image a payment area of the store; and

a warning unit that performs a warning process in a case where it is determined that the person is not included in the third captured image by the second determination unit.

2. The information processing apparatus according to 1,

wherein the second determination unit computes a change in the quantity of products in the exhibition location between before and after a period during which the person is included in the second captured image, staying time of the person in the exhibition location, doubtfulness of an action performed by the person, or a value which represents the doubtfulness of a trajectory of the person, and determines that the degree of doubtfulness of the person is high in a case where the computed value is equal to or larger than a predetermined value.

3. The information processing apparatus according to 1 or 2,

wherein the second captured image used by the second determination unit is a video acquired during a period between a time when the person is imaged by the second camera and a time when the person is imaged by the first camera.

4. The information processing apparatus according to any one of 1 to 3,

wherein the detection unit, the first determination unit, and the second determination unit respectively use the captured images in which the person is imaged from behind.

5. The information processing apparatus according to 4,

wherein the first determination unit determines whether or not the person is included in the second captured image based on any one or more of clothes, a body shape, a color of hair, a color of skin, and possessions of the person detected from the first captured image, and

wherein the second determination unit determines whether or not the person is included in the third captured image based on any one or more of the clothes, the body shape, the color of hair, the color of skin, and the possessions of the person detected from the first captured image.

6. The information processing apparatus according to 4 or 5,

wherein the first determination unit determines whether or not the person detected from the first captured image is included in the second captured image without using eyes, nose, and mouth of the person, and

wherein the second determination unit determines whether or not the person detected from the first captured image is included in the third captured image without using the eyes, the nose, and the mouth of the person.

7. The information processing apparatus according to 6,

wherein the first captured image which is used by the detection unit, the second captured image which is used by the first determination unit, and the third captured image which is used by the second determination unit do not include any of the eyes, the nose, and the mouth of the person.

8. The information processing apparatus according to any one of 1 to 7, further comprising:

an exclusion unit that excludes a captured image which does not include a person other than the person from the captured images to be processed by the detection unit, the first determination unit, and the second determination unit after it is determined that the person is not included in the second captured image by the first determination unit, after it is determined that the degree of doubtfulness of the person is not high by the second determination unit, or after it is determined whether or not the person is included in the third captured image by the second determination unit.

9. The information processing apparatus according to any one of 1 to 8,

wherein the exit is provided with a gate, and

wherein the warning process performed by the warning unit is a process for setting the gate to be unable to be passed through.

10. A control method executed by a computer, comprising:

a detection step of detecting a person from a first captured image, the first captured image being generated by a first camera which is installed to be able to image an exit of a store;

a first determination step of determining whether or not the person detected from the first captured image is included in a second captured image, the second captured image being generated by a second camera which is installed to be able to image an exhibition location of products of the store;

a second determination step of determining whether or not the person who is included in the second captured image and whose degree of doubtfulness is high is included in a third captured image, the third captured image being generated by a third camera which is installed to be able to image a payment area of the store; and

a warning step of performing a warning process in a case where it is determined that the person is not included in the third captured image in the second determination step.

11. The control method according to 10,

wherein the second determination step includes computing a change in the quantity of products in the exhibition location between before and after a period during which the person is included in the second captured image, staying time of the person in the exhibition location, doubtfulness of an action performed by the person, or a value which represents the doubtfulness of a trajectory of the person, and determining that the degree of doubtfulness of the person is high in a case where the computed value is equal to or larger than a predetermined value.

12. The control method according to 10 or 11,

wherein the second captured image used by the second determination step is a video acquired during a period between a time when the person is imaged by the second camera and a time when the person is imaged by the first camera.

13. The control method according to any one of 10 to 12,

wherein the detection step, the first determination step, and the second determination step respectively include using the captured images in which the person is imaged from behind.

14. The control method according to 13,

wherein the first determination step includes determining whether or not the person is included in the second captured image based on any one or more of clothes, a body shape, a color of hair, a color of skin, and possessions of the person detected from the first captured image, and

wherein the second determination step includes determining whether or not the person is included in the third captured image based on any one or more of the clothes, the body shape, the color of hair, the color of skin, and the possessions of the person detected from the first captured image.

15. The control method according to 13 or 14,

wherein the first determination step includes determining whether or not the person detected from the first captured image is included in the second captured image without using eyes, nose, and mouth of the person, and

wherein the second determination step includes determining whether or not the person detected from the first captured image is included in the third captured image without using the eyes, the nose, and the mouth of the person.

16. The control method according to 15,

wherein the first captured image which is used in the detection step, the second captured image which is used in the first determination step, and the third captured image which is used in the second determination step do not include any of the eyes, the nose, and the mouth of the person.

17. The control method according to any one of 10 to 16, further comprising:

an exclusion step of excluding a captured image which does not include a person other than the person from the captured images to be processed in the detection step, the first determination step, and the second determination step after it is determined that the person is not included in the second captured image in the first determination step, after it is determined that the degree of doubtfulness of the person is not high in the second determination step, or after it is determined whether or not the person is included in the third captured image in the second determination step.

18. The control method according to any one of 10 to 17,

wherein the exit is provided with a gate, and

wherein the warning process performed in the warning step is a process for setting the gate to be unable to be passed through.

19. A program causing a computer to execute each step of the control method according to any one of 10 to 18.

1. An information processing apparatus comprising:
a detection unit that detects a person from a first captured image, the first captured image being generated by a first camera which is installed to be able to image an exit of a store;
a first determination unit that determines whether or not the person detected from the first captured image is included in a second captured image, the second captured image being generated by a second camera which is installed to be able to image an exhibition location of products of the store;
a second determination unit that determines whether or not the person who is included in the second captured image and whose degree of doubtfulness is high is included in a third captured image, the third captured image being generated by a third camera which is installed to be able to image a payment area of the store; and
a warning unit that performs a warning process in a case where it is determined that the person is not included in the third captured image by the second determination unit.

2. The information processing apparatus according to claim 1,
wherein the second determination unit computes a change in the quantity of products in the exhibition location between before and after a period during which the person is included in the second captured image, staying time of the person in the exhibition location, doubtfulness of an action performed by the person, or a value which represents the doubtfulness of a trajectory of the person, and determines that the degree of doubtfulness of the person is high in a case where the computed value is equal to or larger than a predetermined value.

3. The information processing apparatus according to claim 1,
wherein the second captured image used by the second determination unit is a video acquired during a period between a time when the person is imaged by the second camera and a time when the person is imaged by the first camera.

4. The information processing apparatus according to claim 1,
wherein the detection unit, the first determination unit, and the second determination unit respectively use the captured images in which the person is imaged from behind.

5. The information processing apparatus according to claim 4,
wherein the first determination unit determines whether or not the person is included in the second captured image based on any one or more of clothes, a body shape, a color of hair, a color of skin, and possessions of the person detected from the first captured image, and
wherein the second determination unit determines whether or not the person is included in the third captured image based on any one or more of the clothes, the body shape, the color of hair, the color of skin, and the possessions of the person detected from the first captured image.

6. The information processing apparatus according to claim 4,
wherein the first determination unit determines whether or not the person detected from the first captured image is included in the second captured image without using eyes, nose, and mouth of the person, and
wherein the second determination unit determines whether or not the person detected from the first captured image is included in the third captured image without using the eyes, the nose, and the mouth of the person.

7. The information processing apparatus according to claim 6,
wherein the first captured image which is used by the detection unit, the second captured image which is used by the first determination unit, and the third captured image which is used by the second determination unit do not include any of the eyes, the nose, and the mouth of the person.

8. The information processing apparatus according to claim 1, further comprising:
an exclusion unit that excludes a captured image which does not include a person other than the person from the captured images to be processed by the detection unit, the first determination unit, and the second determination unit after it is determined that the person is not included in the second captured image by the first determination unit, after it is determined that the degree of doubtfulness of the person is not high by the second determination unit, or after it is determined whether or not the person is included in the third captured image by the second determination unit.

9. The information processing apparatus according to claim 1,
wherein the exit is provided with a gate, and
wherein the warning process performed by the warning unit is a process for setting the gate to be unable to be passed through.

10. A control method executed by a computer, comprising:
detecting a person from a first captured image, the first captured image being generated by a first camera which is installed to be able to image an exit of a store;
determining whether or not the person detected from the first captured image is included in a second captured image, the second captured image being generated by a second camera which is installed to be able to image an exhibition location of products of the store;
determining whether or not the person who is included in the second captured image and whose degree of doubtfulness is high is included in a third captured image, the third captured image being generated by a third camera which is installed to be able to image a payment area of the store; and
performing a warning process in a case where it is determined that the person is not included in the third captured image.

11. The control method according to claim 10, further comprising:
computing a change in the quantity of products in the exhibition location between before and after a period during which the person is included in the second captured image, staying time of the person in the exhibition location, doubtfulness of an action performed by the person, or a value which represents the doubtfulness of a trajectory of the person; and
determining that the degree of doubtfulness of the person is high in a case where the computed value is equal to or larger than a predetermined value.

12. The control method according to claim 10, further comprising:
acquiring, as the second captured images, a frame of a video acquired during a period between a time when the person is imaged by the second camera and a time when the person is imaged by the first camera.

13. The control method according to claim 10,
wherein back of the person is imaged in the first captured image, the second captured image, and the third captured image.

14. The control method according to claim 13,
wherein whether or not the person is included in the second captured image is determined based on any one or more of clothes, a body shape, a color of hair, a color of skin, and possessions of the person detected from the first captured image; and
wherein whether or not the person is included in the third captured image is determined based on any one or more of the clothes, the body shape, the color of hair, the color of skin, and the possessions of the person detected from the first captured image.

15. The control method according to claim 13,
wherein whether or not the person detected from the first captured image is included in the second captured image is determined without using eyes, nose, and mouth of the person, and
wherein whether or not the person detected from the first captured image is included in the third captured image is determined without using the eyes, the nose, and the mouth of the person.

16. The control method according to claim 15,
wherein the first captured image, the second captured image, and the third captured image do not include any of the eyes, the nose, and the mouth of the person.

17. The control method according to claim 10, further comprising:
excluding a captured image which does not include a person other than the person from the captured images to be processed in the control method after it is determined that the person is not included in the second captured image, after it is determined that the degree of doubtfulness of the person is not high, or after it is determined whether or not the person is included in the third captured image.

18. The control method according to claim 10,
wherein the exit is provided with a gate, and
wherein the warning process is a process for setting the gate to be unable to be passed through.

19. A non-transitory computer-readable storage medium storing a program causing a computer to execute each step of the control method according to claim 10.
